(19) United States
(12) Patent Application Publication
(10) Pub. No.: US 2014/0062844 A1
(43) Pub. Date: Mar. 6, 2014

(54) DISPLAY DEVICE AND ELECTRONIC APPARATUS

(71) Applicant: Sony Corporation, Tokyo (JP)

(72) Inventors: Tetsuro Yamamoto, Kanagawa (JP); Katsuhide Uchino, Kanagawa (JP)

(73) Assignee: SONY CORPORATION, Tokyo (JP)

(21) Appl. No.: 13/969,117

(22) Filed: Aug. 16, 2013

(30) Foreign Application Priority Data
Aug. 31, 2012 (JP) 2012-191640

(51) Int. Cl. G09G 3/32

(52) U.S. Cl. CPC G09G 3/3225
USPC 345/80

(57) ABSTRACT

There is provided a display device including pixel circuits which are arranged and each of which includes a driving transistor to drive an electro-optical element and a capacitor connected between a gate electrode and one source/drain electrode of the driving transistor. The driving transistor is configured by stacking the gate electrode and the source/drain electrode and a peripheral portion of the gate electrode is covered by the source/drain electrode.

### BACKGROUND

The present disclosure relates to a display device and an electronic apparatus and more particularly, to a flat panel display device configured by arranging pixels each including an electro-optical element in a matrix and an electronic apparatus including the display device.

As an example of the flat panel display device, a display device that uses a so-called current driving type electro-optical element of which light emission bright changes according to a value of a current flowing to a device as a light emitting unit (light emitting element) of a pixel has been known. As an example of the current driving type electro-optical element, an organic EL (electro luminescence) element that uses electro luminescence of an organic material and uses light emission when an electric field is applied to an organic thin film has been known.

The flat panel display device that is represented by an organic EL display device has a configuration in which pixels (pixel circuits) each of which has at least a write transistor, a capacitor, and a driving transistor in addition to the electro-optical element are two-dimensionally arranged in a matrix (for example, Japanese Patent Application Laid-Open (JP-A) No. 2007-310311).

The write transistor samples a signal voltage of a video signal supplied through a signal line and writes the signal voltage to the pixel. The capacitor is connected between a gate electrode and one source/drain electrode of the driving transistor and retains the signal voltage written by the write transistor. The driving transistor drives the electro-optical element according to the signal voltage retained by the capacity element.

In the pixel circuit, the capacitor is connected between the gate electrode and one source/drain electrode of the driving transistor, so that a bootstrap operation in which a potential of the gate electrode changes according to a potential of one source/drain electrode is performed. In the bootstrap operation, a ratio of a change amount of the potential of the gate electrode with respect to a change amount of the potential of one source/drain electrode of the driving transistor becomes bootstrap gain.

### SUMMARY

Here, the case in which a pixel transistor such as the driving transistor or the write transistor is formed over a semiconductor such as silicon, not an insulator such as a glass substrate, is considered. When the driving transistor is formed over the semiconductor, the bootstrap gain tends to decrease (which will be described in detail below), as compared with when the driving transistor is formed over the insulator.

If the bootstrap gain decreases, it becomes difficult to normally perform an operation of the pixel circuit, which results in deteriorating an image quality of a display image. The decrease in the bootstrap gain is generated equally in the case in which the driving transistor is formed over the insulator formed over the semiconductor such as a metal as well as the case in which the driving transistor is formed over the semiconductor.

It is desirable to provide a display device having a pixel structure that can decrease an image quality defect occurring due to a decrease in bootstrap gain, by devising a structure of a driving transistor, and an electronic apparatus including the display device.

According to an embodiment of the present disclosure, there is provided a display device including pixel circuits which are arranged and each of which includes a driving transistor to drive an electro-optical element and a capacitor connected between a gate electrode and one source/drain electrode of the driving transistor. The driving transistor is configured by stacking the gate electrode and the source/drain electrode and a peripheral portion of the gate electrode is covered by the source/drain electrode.

The display device according to an embodiment of the present disclosure can be used as a display unit in each of various electronic apparatuses including the display unit.

In the display device having the above configuration or the electronic apparatus including the display device, the peripheral portion of the gate electrode of the driving transistor is covered by the source/drain electrode, so that a parasitic capacitor is not generated between the gate electrode of the driving transistor and a metal of other layer. Instead, a parasitic capacitor is generated between the source/drain electrode of the driving transistor and the metal of other layer.

In this case, bootstrap gain is determined by a capacity value of the capacitor and capacity values of parasitic capacitors attached to the gate electrode of the driving transistor. The parasitic capacitor is not generated between the gate electrode of the driving transistor and the metal of other layer, so that the capacity values of the parasitic capacitors attached to the gate electrode decrease. Therefore, the bootstrap gain can be increased.

According to the embodiments of the present disclosure described above, because bootstrap gain can be increased by devising a structure of a driving transistor, an image quality defect occurring due to a decrease in the bootstrap gain can be decreased.

### BRIEF DESCRIPTION OF THE DRAWINGS

FIG. 1 is a system configuration diagram schematically illustrating a basic configuration of an active matrix type display device to which the present disclosure is applied;

FIG. 2 is a circuit diagram illustrating an example of a specific circuit configuration of a pixel (pixel circuit);

FIG. 3 is a timing waveform diagram illustrating a basic circuit operation of an active matrix type organic EL display device to which the present disclosure is applied;

FIG. 4 is an (first) operation explanatory diagram of a basic circuit operation of an active matrix type organic EL display device to which the present disclosure is applied;

FIG. 12 is a diagram illustrating the case in which a TFT is formed over a semiconductor;

FIG. 13 is a diagram illustrating a TFT characteristic in the case in which a TFT is formed over a semiconductor;

FIG. 14 is an equivalent circuit diagram of parasitic capacities of a driving transistor and a write transistor;

FIG. 15 is a timing waveform diagram illustrating an operation in the case in which a TFT is formed over a semiconductor;

FIG. 16 is a circuit diagram illustrating an example of a method of decreasing capacity values of parasitic capacitors attached to a gate electrode of a driving transistor;

FIG. 17 is a cross-sectional view illustrating a multi-layer wiring structure adopted by a process for forming a TFT over a semiconductor substrate;

FIG. 18 is an equivalent circuit diagram of parasitic capacitors attached to a gate electrode of a driving transistor in the case of a multi-layer wiring structure;

FIG. 19 is a cross-sectional view illustrating an example of a multi-layer wiring structure according to an embodiment of the present disclosure; and

FIG. 20 is an equivalent circuit diagram of parasitic capacitors in the case of a multi-layer wiring structure according to an embodiment of the present disclosure.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The following description will be made in the order described below.
1. Display Device and Electronic Apparatus according to Present Disclosure
2. Active Matrix Type Display Device to which Present Disclosure is applied
   2-1. System Configuration
   2-2. Pixel Circuit
   2-3. Basic Circuit Operation
   2-4. Case in which TFT is formed over Semiconductor
3. Embodiment
4. Modification
5. Electronic Apparatus
6. Configuration of Present Disclosure

### <1. Display Device and Electronic Apparatus According to Present Disclosure>

A display device according to an embodiment of the present disclosure is a flat panel display device configured by arranging pixel circuits each of which has an electro-optical element, a driving transistor to drive the electro-optical element, and a capacitor connected between a gate electrode and one source/drain electrode of the driving transistor.

As the flat panel display device, an organic EL display device, a liquid crystal display device, and a plasma display device can be exemplified. Among these display devices, the organic EL display device uses electro luminescence of an organic material and uses an organic EL element using light emission when an electric field is applied to an organic thin film as a light emitting element (electro-optical element) of a pixel.

The organic EL display device that uses the organic EL element as a light emitting unit of the pixel has the following features. That is, because the organic EL element can be driven with an application voltage of 10 V or less, consumption power of the organic EL display device is low. Because the organic EL element is a self-emission element, the organic EL display device has the following advantages, as compared with the liquid crystal display device to be the same flat panel display device. That is, in the organic EL display device, visibility of an image is high and it is not necessary to provide an illumination member such as a backlight. Therefore, weight and thickness can be easily decreased in the organic EL display device. Further, because the organic EL element has a very high operation speed of about several μsec, a residual image when a moving image is displayed is not generated in the organic EL display device.

The organic EL element is a current driving type electro-optical element. As the current driving type electro-optical element, in addition to the organic EL element, an inorganic EL element, an LED element, and a semiconductor laser element can be exemplified.

The flat panel display device such as the organic EL display device can be used as a display unit (display device) in various electronic apparatuses including the display unit. As the various electronic apparatuses, a portable information apparatus such as a digital camera., a video camera, a game machine, a notebook computer, or an electronic book reader and a portable communication apparatus such as a personal digital assistant (PDA) or a mobile phone can be exemplified.

In the display device that has the pixel circuits with the configuration described above, the driving transistor has a structure in which a gate electrode and a source/drain electrode are stacked and the source/drain electrode covers a peripheral portion of the gate electrode of the driving transistor.

In the display device and the electronic apparatus according to an embodiment of the present disclosure that have the preferred configuration described above, the driving transistor can have a structure in which the source/drain electrode covers a peripheral portion of a channel formation layer.

In the display device and the electronic apparatus according to an embodiment of the present disclosure that have the preferred configuration described above, the driving transistor can be formed over a semiconductor such as silicon. When a transistor is formed over the semiconductor, the transistor becomes a four-terminal element of a gate terminal, a source terminal, a drain terminal, and a back gate (base) terminal. When the driving transistor is formed over the semiconductor, bootstrap gain tends to decrease, as compared with when the driving transistor is formed over an insulator.

In the display device and the electronic apparatus according to an embodiment of the present disclosure that have the preferred configuration described above, the driving transistor can be formed over the insulator formed over a conductor such as a metal. When the transistor is formed over the insulator formed over the conductor, the transistor becomes a three-terminal element of the gate terminal, the source terminal, and the drain terminal, not the four-terminal element.

Even when the driving transistor is formed over the insulator formed over the conductor, similar to when the driving transistor is formed over the semiconductor, the bootstrap gain tends to decrease, as compared with when the driving transistor is formed over the insulator. This is because an entire portion between a semiconductor substrate and the gate electrode may become a parasitic capacitor, when a transistor having a bottom gate structure is formed over the semiconductor substrate with the insulator therebetween.

In the display device and the electronic apparatus according to an embodiment of the present disclosure that have the preferred configuration described above, the pixel circuit can have a structure in which writing of a video signal and correction of mobility of the driving transistor are performed while a current is made to flow to the driving transistor. At this time, the correction of the mobility of the driving transistor can be performed by applying negative feedback to a potential difference between the gate and the source of the driving transistor, with a correction amount according to the current flowing to the driving transistor.

### <2. Active Matrix Type Display Device to Which Present Disclosure is Applied>

### [2-1. System Configuration]

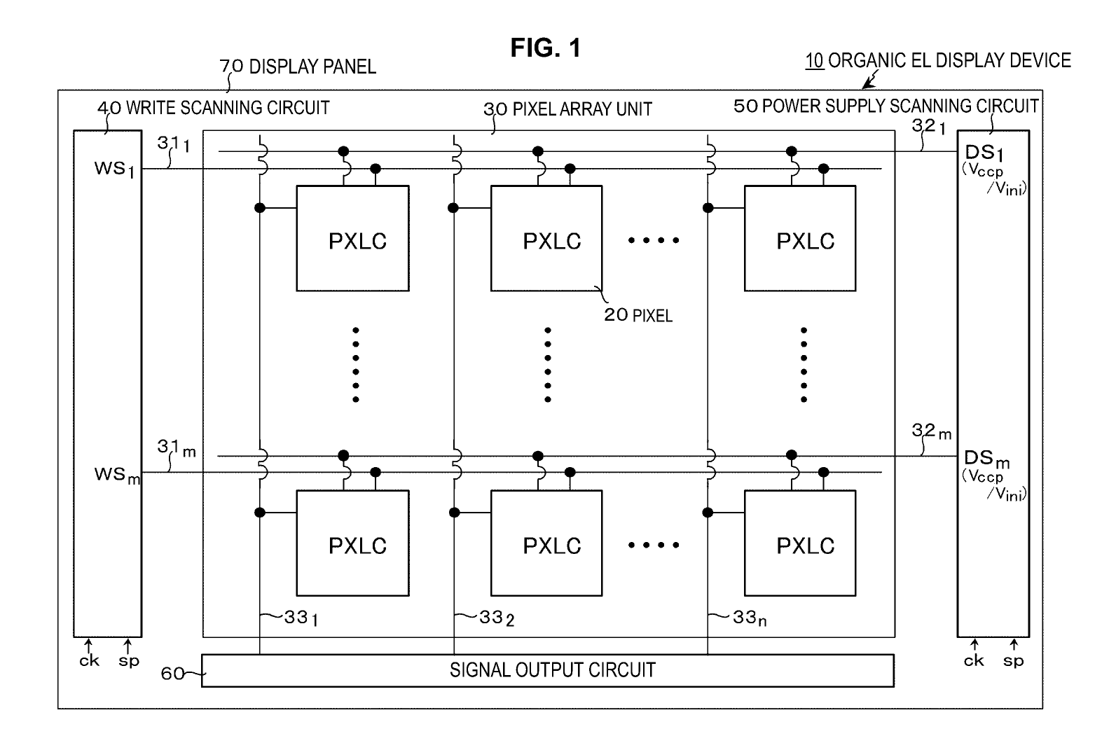

FIG. 1 is a system configuration diagram schematically illustrating a basic configuration of an active matrix type display device to which the present disclosure is applied.

The active matrix type display device is a display device in which a current flowing to the electro-optical element is controlled by an active element provided in the same pixel as the electro-optical element, for example, an insulating gate type field effect transistor. As the insulating gate type field effect transistor, a thin film transistor (TFT) is typically used.

Here, an example of the case of an active matrix type organic EL display device in which an organic EL element to be a current driving type electro-optical element of which light emission brightness changes according to a value of a current flowing to a device is used as a light emitting element of a pixel (pixel circuit) will be described.

As illustrated in FIG. 1, an organic EL display device 10 that becomes the premise of an embodiment of the present disclosure includes a pixel array unit 30 configured by two-dimensionally arranging a plurality of pixels 20 each having an organic EL element in a matrix and a driving circuit unit (driving unit) arranged in a peripheral portion of the pixel array unit 30. The driving circuit unit includes a write scanning circuit 40, a power supply scanning circuit 50, and a signal output circuit 60 and drives each pixel 20 of the pixel array unit 30.

Here, when the organic EL display device 10 corresponds to color display, one pixel (unit pixel) becoming a formation unit of a color image includes a plurality of sub-pixels and each of the sub-pixels corresponds to the pixel 20 illustrated in FIG. 1. Specifically, in the display device that corresponds to the color display, one pixel includes three sub-pixels of a sub-pixel to emit red (R) light, a sub-pixel to emit green (G) light, and a sub-pixel to emit blue (B) light.

However, one pixel is not limited to a combination of sub-pixels of three primary colors of R, G, and B and may be configured by adding sub-pixels of one or more colors to the sub-pixels of the three primary colors. Specifically, one pixel may be configured by providing a sub-pixel to emit white (W) light to improve brightness, in addition to the sub-pixels of the three primary colors. Alternatively, one pixel may be configured by providing at least one sub-pixel to emit complementary light to enlarge a color reproduction range, in addition to the sub-pixels of the three primary colors.

In the pixel array unit 30, scanning lines 31₁ to 31ₘ and power supply lines 32₁ to 32ₘ are provided along a row direction (arrangement direction of the pixels of pixel rows), for every pixel row, with respect to an arrangement of the pixels 20 of m rows and n columns. In addition, signal lines 33₁ to 33ₙ are provided along a column direction (arrangement direction of the pixels of pixel columns), for every pixel column, with respect to the arrangement of the pixels 20 of the m rows and the n columns.

Each of the scanning lines 31₁ to 31ₘ is connected to an output terminal of a corresponding row of the write scanning circuit 40. Each of the power supply lines 32₁ to 32ₘ is connected to an output terminal of a corresponding row of the power supply scanning circuit 50. Each of the signal lines 33₁ to 33ₙ is connected to an output terminal of a corresponding column of the signal output circuit 60.

The write scanning circuit 40 is configured using a shift register circuit that sequentially shifts (transmits) start pulses sp in synchronization with a clock pulse ck. The write scanning circuit 40 sequentially supplies write scanning signals WS (WS₁ to WSₘ) to the scanning lines 31 (31₁ to 31ₘ) and sequentially scans the individual pixels 20 of the pixel array unit 30 in a row unit (line-sequential scanning), when a signal voltage of a video signal is written to each pixel 20 of the pixel array unit 30.

The power supply scanning circuit 50 is configured using a shift register circuit that sequentially shifts the start pulses sp in synchronization with the clock pulse ck. The power supply scanning circuit 50 supplies, to the power supply lines 32 (32₁ to 32ₘ), power supply potentials DS (DS₁ to DSₘ), which can be switched into a first power supply potential V_{ccp} and a second power supply potential Vᵢₙᵢ lower than the first power supply potential V_{ccp}, in synchronization with the line-sequential scanning by the write scanning circuit 40. As described below, the power supply potential DS is switched into V_{ccp}/Vᵢₙᵢ, so that control of light emission/light non-emission (quenching) of the pixel 20 is performed.

The signal output circuit 60 selectively outputs a signal voltage V_{sig} of a video signal according to brightness information supplied from a signal supply source (not illustrated in the drawings) (hereinafter, simply referred to as the “signal voltage”) and a reference voltage V_{ofs}. In this case, the reference voltage V_{ofs} is a voltage becoming a reference of the signal voltage V_{sig} of the video signal (for example, a voltage corresponding to a black level of the video signal) and is used when threshold value correction processing to be described below is executed.

The signal voltage V_{sig}/reference voltage V_{ofs} that is output from the signal output circuit 60 is written to each pixel 20 of the pixel array unit 30 through the signal lines 33 (33₁ to 33ₙ), in a unit of the pixel row selected by scanning by the write scanning circuit 40. That is, the signal output circuit 60 adopts a driving type of line-sequential writing in which the signal voltage V_{sig} is written in a row (line) unit.

### [2-2. Pixel Circuit]

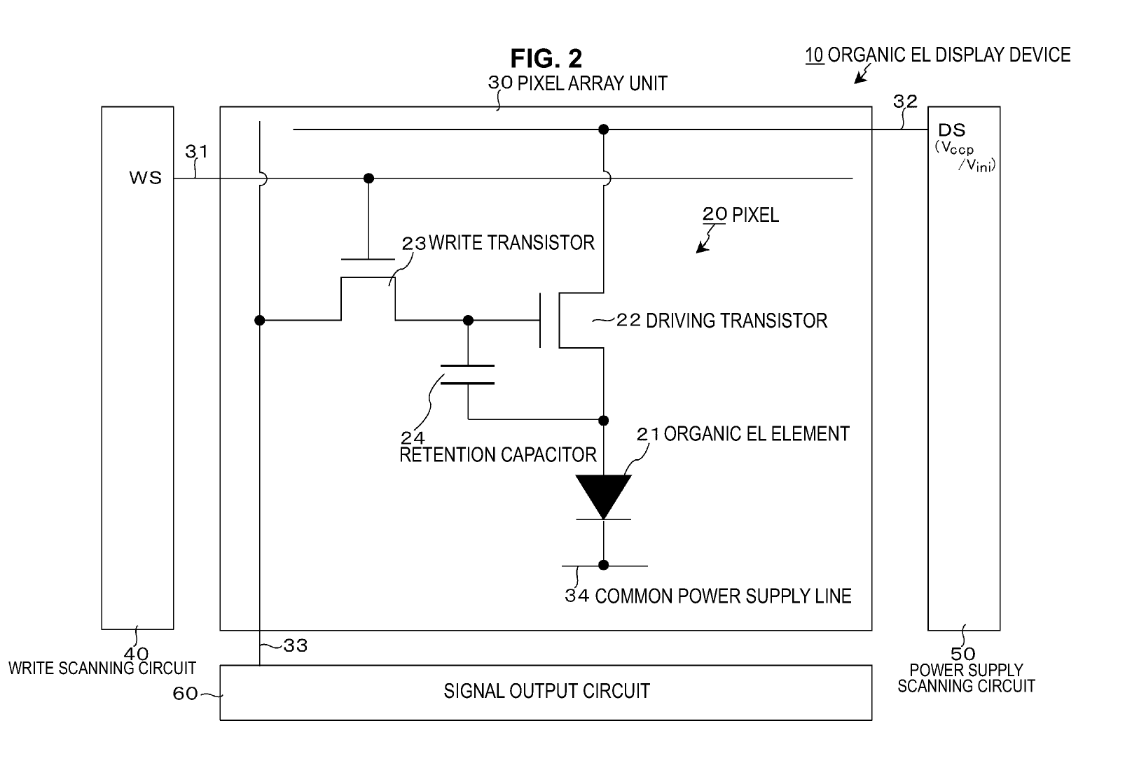

FIG. 2 is a circuit diagram illustrating an example of a specific circuit configuration of the pixel (pixel circuit) 20. A light emitting unit of the pixel 20 is configured using an organic EL element 21 to be a current driving type electro-optical element of which light emission brightness changes according to a value of a current flowing to a device.

As illustrated in FIG. 2, the pixel 20 includes the organic EL element 21 and a driving circuit that drives the organic EL element 21 by making a current flow to the organic EL element 21. In the organic EL element 21, a cathode electrode is connected to a common power supply line 34 provided commonly with respect to all of the pixels 20.

The driving circuit that drives the organic EL element 21 includes a driving transistor 22, a write transistor 23, and a retention capacitor 24. As the driving transistor 22 and the write transistor 23, N-channel TFTs can be used. However, a combination of conductive types of the driving transistor 22 and the write transistor 23 that are illustrated herein is only exemplary and the combination of the conductive types thereof is not limited to a specific combination of conductive types.

In the driving transistor 22, one electrode (source/drain electrode) is connected to an anode electrode of the organic EL element 21 and the other electrode (source/drain electrode) is connected to the power supply line 32 (32₁ to 32ₘ).

In the write transistor 23, one electrode (source/drain electrode) is connected to the signal line 33 (33₁ to 33ₙ) and the other electrode (source/drain electrode) is connected to a gate electrode of the driving transistor 22. In addition, a gate electrode of the write transistor 23 is connected to the scanning line 31 (31₁ to 31ₘ).

In the driving transistor 22 and the write transistor 23, one electrode means a metal wiring line that is electrically connected to one source/drain region and the other electrode means a metal wiring line that is electrically connected to the other source/drain region. By a potential relation of one electrode and the other electrode, if one electrode becomes a source electrode, one electrode becomes a drain electrode and if the other electrode becomes the drain electrode, the other electrode becomes the source electrode.

In the retention capacitor 24, one electrode is connected to the gate electrode of the driving transistor 22 and the other electrode is connected to the other electrode of the driving transistor 22 and the anode electrode of the organic EL element 21.

A circuit configuration of the driving circuit of the organic EL element 21 is not limited to a circuit configuration including two transistors of the driving transistor 22 and the write transistor 23 and one capacitor of the retention capacitor 24. For example, one electrode is connected to the anode electrode of the organic EL element 21 and the other electrode is connected to a fixed potential, so that a circuit configuration in which an auxiliary capacitor to make up for an insufficient capacity of the organic EL element 21 is provided according to necessity can be adopted.

In the pixel 20 having the above configuration, the write transistor 23 enters a conductive state in response to the write scanning signal WS that is applied from the write scanning circuit 40 to the gate electrode through the scanning line 31 and becomes active at a high level. Thereby, the write transistor 23 samples the signal voltage V_{sig} of the video signal according to the brightness information to be supplied from the signal output circuit 60 through the signal line 33 or the reference voltage V_{ofs} and writes the signal voltage V_{sig} or the reference voltage V_{ofs} to the pixel 20. The signal voltage V_{sig} or the reference voltage V_{ofs} that is written by the write transistor 23 is applied to the gate electrode of the driving transistor 22 and is retained in the retention capacitor 24.

When the power supply potential DS of the power supply line 32 (32₁ to 32ₘ) is at the first power supply potential V_{ccp}, one electrode and the other electrode of the driving transistor 22 become the drain electrode and the source electrode, respectively, and the driving transistor 22 is operated in a saturation region. Thereby, the driving transistor 22 receives a current supplied from the power supply line 32 and drives light emission of the organic EL element 21 by current driving. Specifically, the driving transistor 22 is operated in the saturation region, supplies a driving current having a current value according to a voltage value of the signal voltage V_{sig} retained in the retention capacitor 24 to the organic EL element 21, and makes the organic EL element 21 emit light by the current driving.

When the power supply potential DS is switched from the first power supply potential V_{ccp} to the second power supply potential Vᵢₙᵢ, one electrode and the other electrode of the driving transistor 22 become the source electrode and the drain electrode, respectively, and the driving transistor 22 is operated as a switching transistor. Thereby, the driving transistor 22 stops supplying of the driving current with respect to the organic EL element 21 and makes the organic EL element 21 enter a light non-emission state. That is, the driving transistor 22 has a function as a transistor to control light emission/light non-emission of the organic EL element 21.

By setting a period (light non-emission period) in which the organic EL element 21 enters the light non-emission state by a switching operation of the driving transistor 22, a ratio (duty) of a light emission period and a light non-emission period of the organic EL element 21 can be controlled. Because it is possible to decrease residual image blur occurring due to light emission of the pixel over one display frame period by the duty control, an image quality of a moving image can be improved in particular.

The first power supply potential V_{ccp} of the first and second power supply potentials V_{ccp} and Vᵢₙᵢ that are supplied selectively from the power supply scanning circuit 50 through the power supply line 32 is a power supply potential to supply a driving current to drive light emission of the organic EL element 21 to the driving transistor 22. The second power supply potential Vᵢₙᵢ is a power supply potential to apply reverse bias to the organic EL element 21. The second power supply potential Vᵢₙᵢ is set to a potential lower than the reference voltage V_{ofs}. For example, when a threshold voltage of the driving transistor 22 is set to Vₜₕ, the second power supply potential Vᵢₙᵢ is set to a potential lower than V_{ofs}−Vₜₕ, preferably, a potential sufficiently tower than V_{ofs}−Vₜₕ.

### [2-3. Basic Circuit Operation]

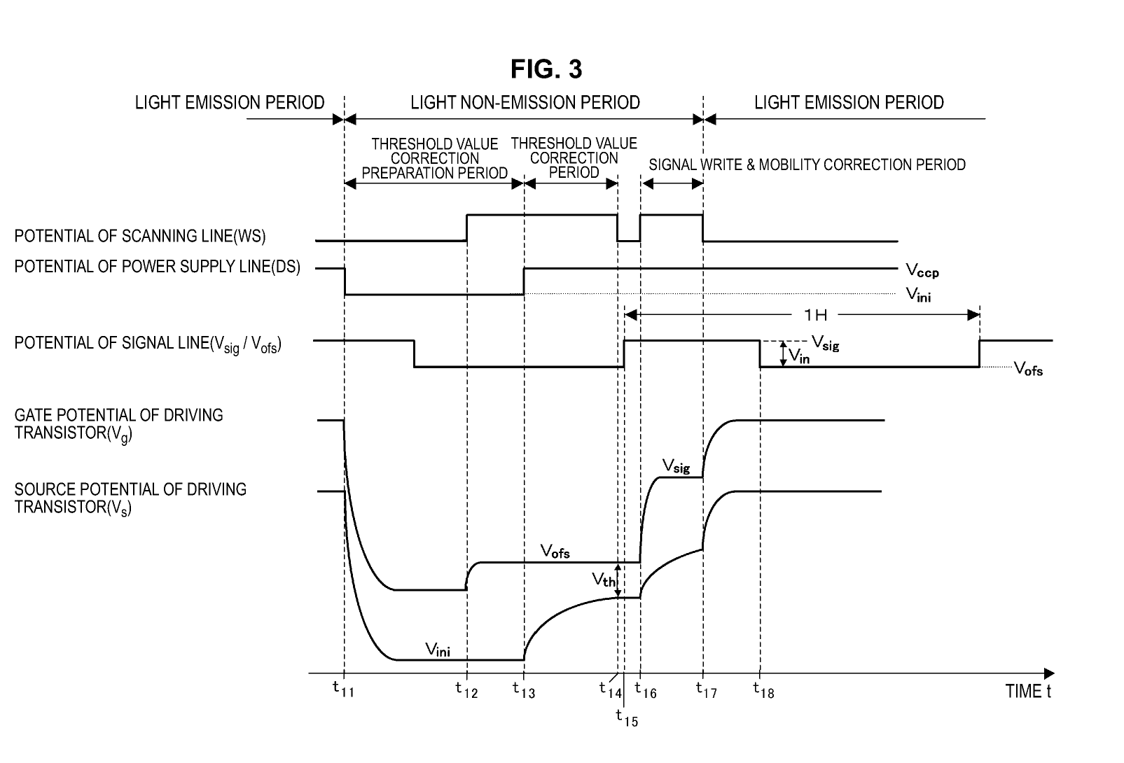

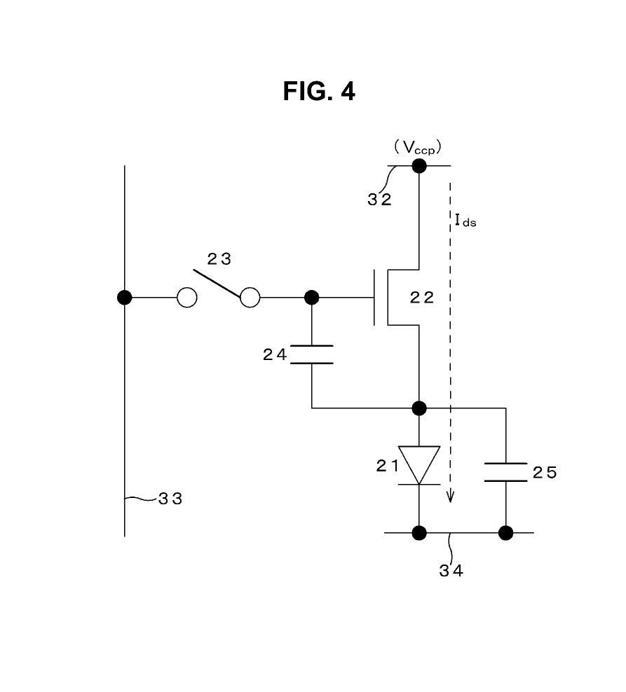

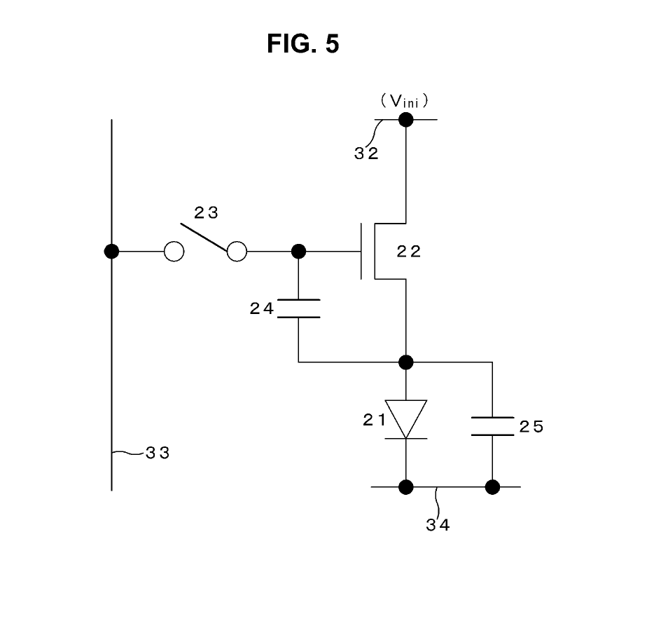

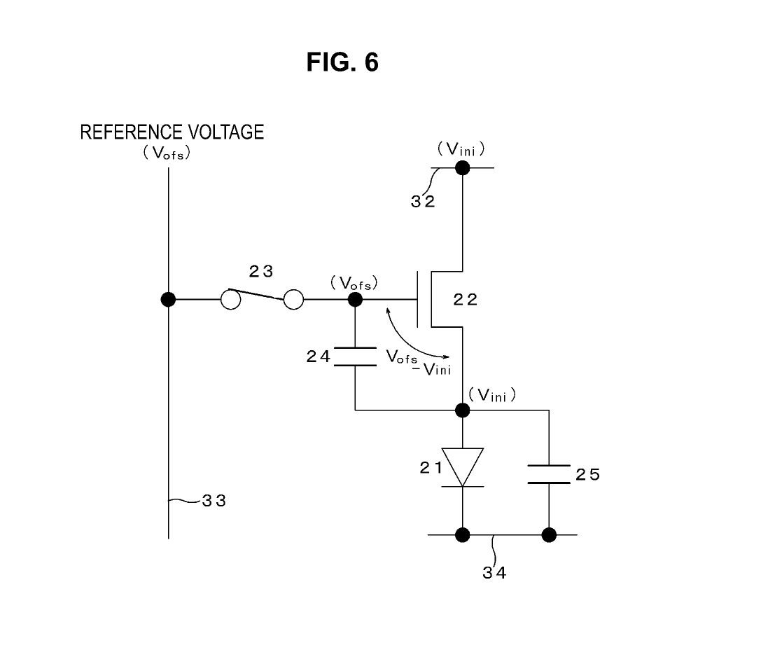

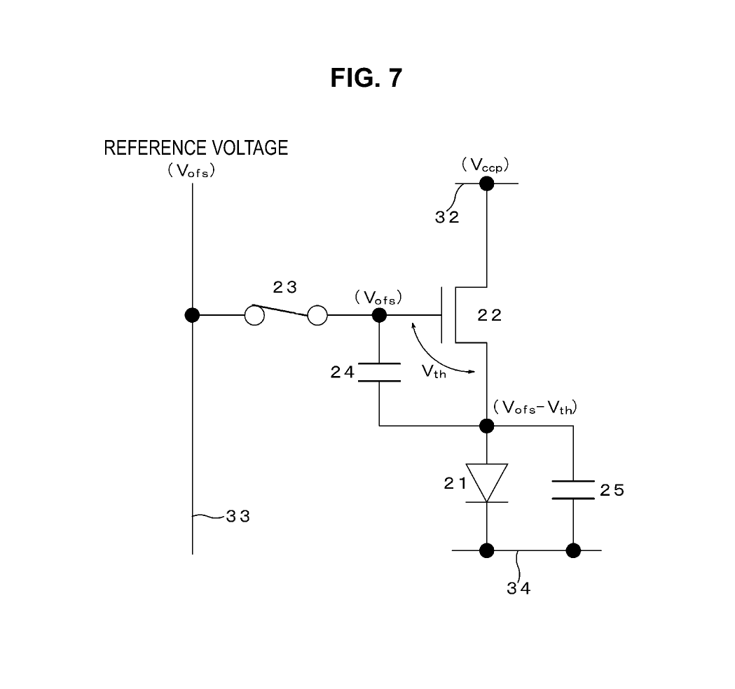

Next, a basic circuit operation of the organic EL display device 10 having the above configuration will be described using a timing waveform diagram of FIG. 3 and with reference to operation explanatory diagrams of FIGS. 4 to 11. In the operation explanatory diagrams of FIGS. 4 to 11, the write transistor 23 is illustrated by a symbol of a switch to simplify the drawings and an equivalent capacitor 25 of the organic EL element 21 is also illustrated.

The timing waveform diagram of FIG. 3 illustrates a change of each of the potential (write scanning signal) WS of the scanning line 31, the potential (power supply potential) DS of the power supply line 32, the potential (V_{sig}/V_{ofs}) of the signal line 33, and the gate potential V_{g} and the source potential Vₛ of the driving transistor 22.

### (Light Emission Period of Previous Display Frame)

In the timing waveform diagram of FIG. 3, a period before a time t₁₁ becomes a light emission period of the organic EL element 21 in a previous display frame. In the light emission period of the previous display frame, the potential DS of the power supply line 32 is at the first power supply potential (hereinafter, referred to as a “high potential”) and the write transistor 23 is in a non-conductive state.

At this time, the driving transistor 22 is set to be operated in the saturation region. Thereby; as illustrated in FIG. 4, a driving current (drain-source current) I_{ds} according to a gate-source voltage V_{gs} of the driving transistor 22 is supplied from the power supply line 32 to the organic EL element 21 through the driving transistor 22. Therefore, the organic EL element 21 emits light with brightness according to a current value of the driving current I_{ds}.

### (Threshold Value Correction Preparation Period)

If a time becomes the time t₁₁, a new display frame (current display frame) of the line-sequential scanning starts. As illustrated in FIG. 5, the potential DS of the power supply line 32 is switched from the high potential V_{ccp} to the second power supply potential (hereinafter, referred to as a “low potential”) Vᵢₙᵢ. The low potential Vᵢₙᵢ is a potential that is sufficiently lower than V_{ofs}−Vₜₕ with respect to the reference voltage V_{ofs} of the signal line 33.

In this case, the threshold voltage of the organic EL element 21 is set to Vₜₕₑ₁ and the potential (cathode potential) of the common power supply line 34 is set to V_{cath}. At this time, if the low potential Vᵢₙᵢ is set to Vᵢₙᵢ<Vₜₕₑ₁+V_{cath}, the organic EL element 21 enters a reverse bias state and quenches, because the source potential Vₛ of the driving transistor 22 becomes almost equal to the low potential Vᵢₙᵢ.

Next, at a time t₁₂, the potential WS of the scanning line 31 changes from the low potential side to the high potential side, so that the write transistor 23 enters a conductive state, as illustrated in FIG. 6. At this time, because the reference voltage V_{ofs} is supplied from the signal output circuit 60 to the signal line 33, the gate potential V_{g} the driving transistor 22 becomes the reference voltage V_{ofs}. The source potential Vₛ of the driving transistor 22 is at the potential sufficiently lower than the reference voltage V_{ofs}, that is, the low potential Vᵢₙᵢ.

At this time, the gate-source voltage V_{gs} of the driving transistor 22 becomes V_{ofs}−Vᵢₙᵢ. If V_{ofs}−Vᵢₙᵢ is not more than the threshold voltage Vₜₕ of the driving transistor 22, threshold value correction processing (threshold value correction operation) to be described below may not be executed. For this reason, it is necessary to set a potential relation of V_{ofs}−Vᵢₙᵢ>Vₜₕ.

As such, processing for fixing the gate potential V_{g} of the driving transistor 22 to the reference voltage V_{ofs} and fixing the source potential Vₛ to the low potential Vᵢₙᵢ to perform initialization is preparation (threshold value correction preparation) processing before executing the threshold value correction processing (threshold value correction operation) to be described below. Therefore, the reference voltage V_{ofs} and the low potential Vᵢₙᵢ become initialization voltages of the gate potential V_{g} and the source potential Vₛ of the driving transistor 22.

### (Threshold Value Correction Period)

Next, at a time t₁₃, as illustrated in FIG. 7, if the potential DS of the power supply line 32 is switched from the low potential Vᵢₙᵢ to the high potential V_{ccp}, the threshold value correction processing starts in a state in which the gate potential V_{g} of the driving transistor 22 is maintained at the reference voltage V_{ofs}. That is, the source potential Vₛ of the driving transistor 22 starts to increase to the potential obtained by subtracting the threshold voltage Vₜₕ of the driving transistor 22 from the gate potential V_{g}.

In this case, for the convenience of explanation, processing for setting the initialization voltage V_{ofs} of the gate potential V_{g} of the driving transistor 22 to the reference voltage and changing the source potential Vₛ to the potential obtained by subtracting the threshold voltage Vₜₕ of the driving transistor 22 from the initialization voltage V_{ofs} is called the threshold value correction processing. If the threshold value correction processing advances, the gate-source voltage V_{gs} of the driving transistor 22 eventually converges to the threshold voltage Vₜₕ of the driving transistor 22. The voltage that corresponds to the threshold voltage Vₜₕ is retained in the retention capacitor 24.

In the period in which the threshold value correction processing is executed (threshold value correction period), the potential V_{cath} of the common power supply line 34 is set to make the organic EL element 21 enter a cutoff state, such that a current flows to only the side of the retention capacitor 24 and does not flow to the side of the organic EL element 21.

Next, at a time t₁₄, the potential WS of the scanning line 31 changes to the low potential side, so that the write transistor 23 enters a non-conductive state, as illustrated in FIG. 8. At this time, the gate electrode of the driving transistor 22 is electrically isolated from the signal line 33 and enters a floating state. However, because the gate-source voltage V_{gs} is equal to the threshold voltage Vₜₕ of the driving transistor 22, the driving transistor 22 is in a cutoff state. Therefore, the drain-source current I_{ds} does not flow to the driving transistor 22.

### (Signal Write & Mobility Correction Period)

Next, at a time t₁₅, as illustrated in FIG. 9, the potential of the signal line 33 is switched from the reference voltage V_{ofs} to the signal voltage V_{sig} of the video signal. Next, at a time t₁₆, the potential WS of the scanning line 31 changes to the high potential side, so that the write transistor 23 enters a conductive state, samples the signal voltage V_{sig} of the video signal, and writes the signal voltage to the pixel 20, as illustrated in FIG. 10.

By writing the signal voltage V_{sig} by the write transistor 23, the gate potential V_{g} of the driving transistor 22 becomes the signal voltage V_{sig}. When the driving transistor 22 is driven by the signal voltage V_{sig} of the video signal, the threshold voltage Vₜₕ of the driving transistor 22 is cancelled by a voltage corresponding to the threshold voltage Vₜₕ retained in the retention capacitor 24.

At this time, the organic EL element 21 is in a cutoff state (high impedance state). Therefore, the current (drain-source current I_{ds}) that flows from the power supply line 32 to the driving transistor 22 according to the signal voltage V_{sig} of the video signal flows to the equivalent capacitor 25 of the organic EL element 21. Thereby, charging of the equivalent capacitor 25 of the organic EL element 21 starts.

The equivalent capacitor 25 of the organic EL element 21 is charged, so that the source potential Vₛ of the driving transistor 22 increases over time. At this time, a variation of the threshold voltage Vₜₕ of the driving transistor 22 for each pixel is already cancelled and the drain-source current I_{ds} of the driving transistor 22 depends on the mobility μ of the driving transistor 22. The mobility μ of the driving transistor 22 is mobility of a semiconductor thin film that constitutes a channel of the driving transistor 22.

Here, it is assumed that a ratio of the retention voltage V_{gs} of the retention capacitor 24 with respect to the signal voltage V_{sig} of the video signal, that is, write gain G is 1 (ideal value). In this case, the source potential Vₛ of the driving transistor 22 increases to a potential of V_{ofs}−Vₜₕ+ΔV, so that the gate-source voltage V_{gs} of the driving transistor 22 becomes V_{sig}−V_{ofs}+Vₜₕ−ΔVₛ.

That is, an increased potential ΔVₛ of the source potential Vₛ of the driving transistor 22 is deducted from the voltage (V_{sig}−V_{ofs}+Vₜₕ) retained in the retention capacitor 24, that is, charging charges of the retention capacitor 24 are discharged. In other words, the increased potential (change amount) ΔVₛ of the source potential Vₛ of the driving transistor 22 is generated by applying the negative feedback to the retention capacitor 24. Therefore, the increased potential ΔVₛ of the source potential Vₛ becomes a feedback amount of the negative feedback.

As such, the negative feedback is applied to the gate-source voltage V_{gs} with the feedback amount ΔVₛ according to the drain-source current I_{ds} flowing to the driving transistor 22 to cancel dependency of the drain-source current I_{ds} of the driving transistor 22 with respect to the mobility μ. The cancellation processing is mobility correction processing for correcting the variation of the mobility μ of the driving transistor 22 for each pixel.

Specifically, because the drain-source current I_{ds} increases when signal amplitude Vᵢₙ(=V_{sig}−V_{ofs}) of the video signal written to the gate electrode of the driving transistor 22 increases, an absolute value of the feedback amount ΔVₛ of the negative feedback increases. Therefore, the mobility correction processing according to a light emission brightness level is executed.

When the signal amplitude Vᵢₙ of the video signal is constant, the absolute value of the feedback amount ΔVₛ of the negative feedback increases when the mobility μ of the driving transistor 22 increases. For this reason, the variation of the mobility μ for each pixel can be removed. Therefore, the feedback amount ΔVₛ of the negative feedback is also called a correction amount of the mobility correction processing.

### (Light Emission Period)

Next, at a time t₁₇, the potential WS of the scanning line 31 changes to the low potential side, so that the write transistor 23 enters a non-conductive state, as illustrated in FIG. 11. Thereby, because the gate electrode of the driving transistor 22 is electrically isolated from the signal line 33, the gate electrode enters a floating state.

In this case, when the gate electrode of the driving transistor 22 is in a floating state, the retention capacitor 24 is connected between the gate and the source of the driving transistor 22, so that the gate potential V_{g} changes in tandem with a change in the source potential Vₛ of the driving transistor 22. That is, the source potential Vₛ and the gate potential V_{g} of the driving transistor 22 increase in a state in which the gate-source voltage V_{gs} retained in the retention capacitor 24 is retained. In addition, the source potential Vₛ of the driving transistor 22 increases to a light emission voltage V_{oled} of the organic EL element 21 according to a saturation current I_{ds} of the transistor.

As such, an operation in which the gate potential V_{g} of the driving transistor 22 changes in tandem with the change in the source potential Vₛ is a bootstrap operation. In other words, the bootstrap operation is an operation in which the gate potential V_{g} and the source potential Vₛ change, in a state in which the gate-source voltage V_{gs} retained in the retention capacitor 24, that is, a voltage between both ends of the retention capacitor 24 is retained.

At the same time as when the gate electrode of the driving transistor 22 enters a floating state, the drain-source current I_{ds} of the driving transistor 22 starts to flow to the organic EL element 21, so that the anode potential of the organic EL element 21 increases according to the drain-source current I_{ds}. If the anode potential of the organic EL element 21 is more than Vₜₕₑ₁+V_{cath}, the organic EL element 21 starts light emission, because a driving current starts to flow to the organic EL element 21.

A light emission current of the organic EL element 21 is defined by the saturation current I_{ds} of the driving transistor 22 by the gate-source voltage V_{gs} at that time. For this reason, the driving transistor 22 becomes a constant current source at each signal voltage V_{sig}.

An increase in the anode potential of the organic EL element 21 is an increase in the source potential Vₛ of the driving transistor 22. If the source potential Vₛ of the driving transistor 22 increases, the gate potential V_{g} of the driving transistor 22 increases in tandem with the increase in the source potential Vₛ, by the bootstrap operation of the retention capacitor 24.

At this time, when it is assumed that bootstrap gain is 1 (ideal value), an increased amount of the gate potential V_{g} becomes equal to an increased amount of the source potential Vₛ. For this reason, during the light emission period, the gate-source voltage V_{gs} of the driving transistor 22 is retained constantly at V_{sig}−V_{ofs}+Vₜₕ−ΔVₛ. At a time t₁₈, the potential of the signal line 33 is switched from the signal voltage V_{sig} of the video signal to the reference voltage V_{ofs}.

In the series of circuit operations described above, each processing operation of the threshold value correction preparation, the threshold value correction, the writing of the signal voltage V_{sig} (signal write), and the mobility correction is executed in one horizontal period (1H). In addition, each processing operation of the signal write and the mobility correction is executed in parallel, in a period from a time t₁₆ to a time t₁₇.

### [Division Threshold Value Correction]

The case in which the driving method of executing the threshold value correction processing only once is adopted has been described. However, the driving method is only exemplary and is not limited in particular. For example, a driving method of executing so-called division threshold value correction where the threshold value correction processing is divided and is executed several times over the 1H period in which the threshold value correction processing is executed together with the mobility correction processing and the signal write processing and a plurality of horizontal periods before the 1H period can be adopted.

According to the driving method of executing the division threshold value correction, even though a time allocated as one horizontal period becomes short due to more pixels according to high definition, a sufficient time can be secured over the plurality of horizontal periods functioning as the threshold value correction period. Therefore, even though the time allocated as one horizontal period becomes short, the sufficient time can be secured as the threshold value correction period. As a result, the threshold value correction processing can be securely executed.

### [2-4. Case in Which TFT is Formed Over Semiconductor]

Here, the case in which a TFT used as the driving transistor 22 or the write transistor 23 is formed over a semiconductor such as silicon, not an insulator such as a glass substrate, is considered.

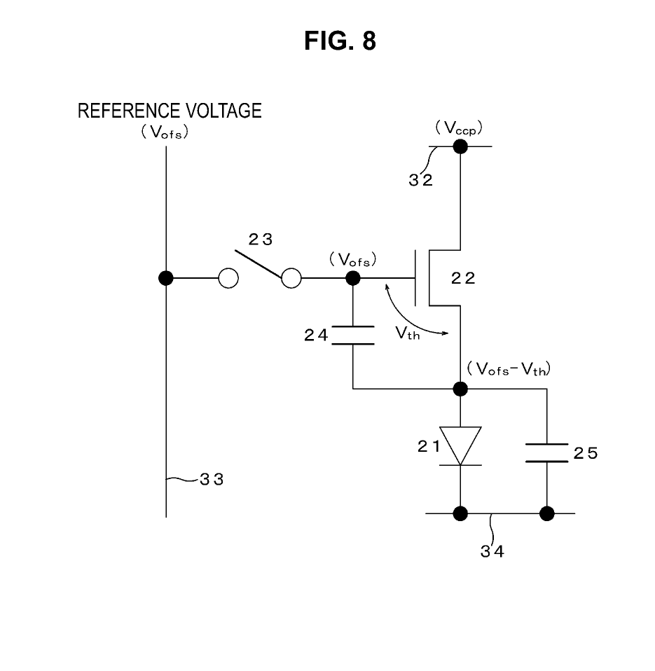

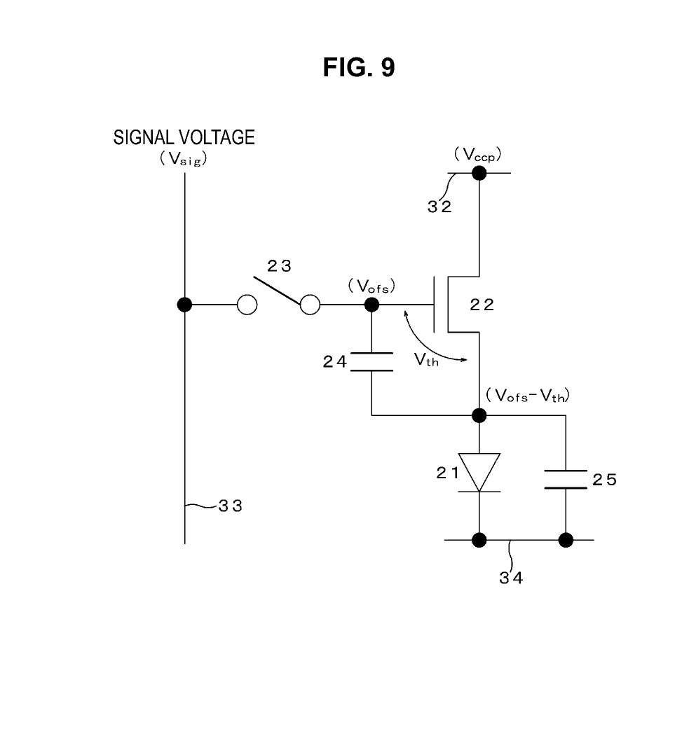

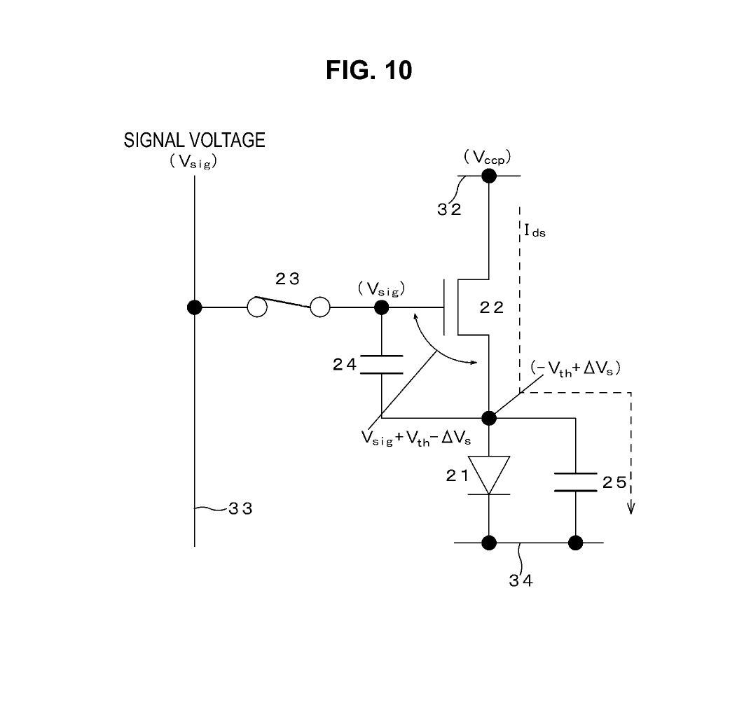

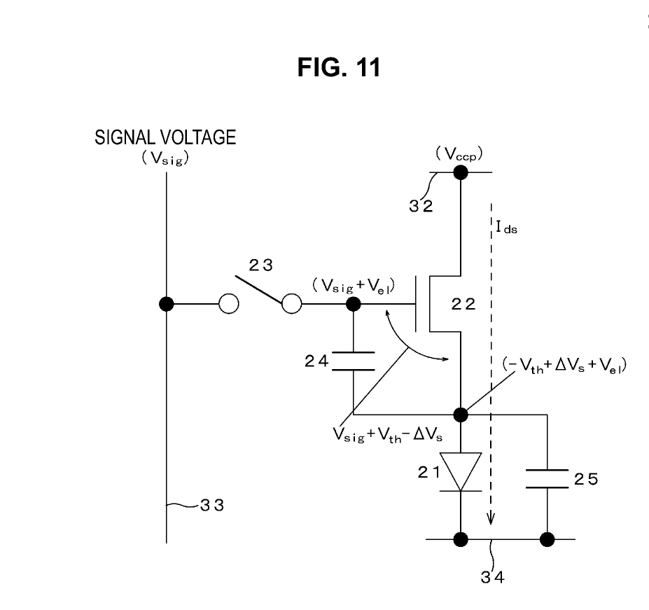

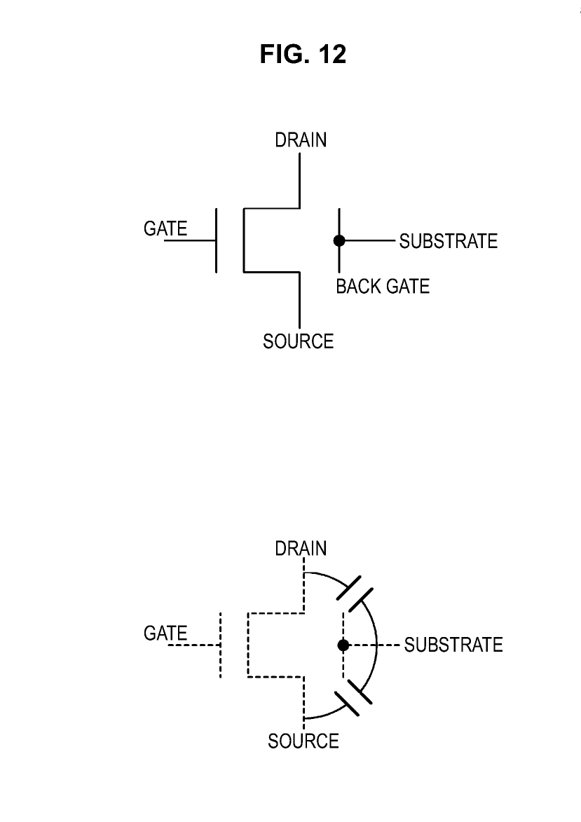

When the TFT is formed over the semiconductor, as illustrated in FIG. 12, the TFT becomes a four-terminal element of a source terminal, a gate terminal, a drain terminal, and a back gate (base) terminal, not a three-terminal element of the source terminal, the gate terminal, and the drain terminal. A parasitic capacitor exists between the source terminal, the gate terminal, and the drain terminal (electrode) and a substrate.

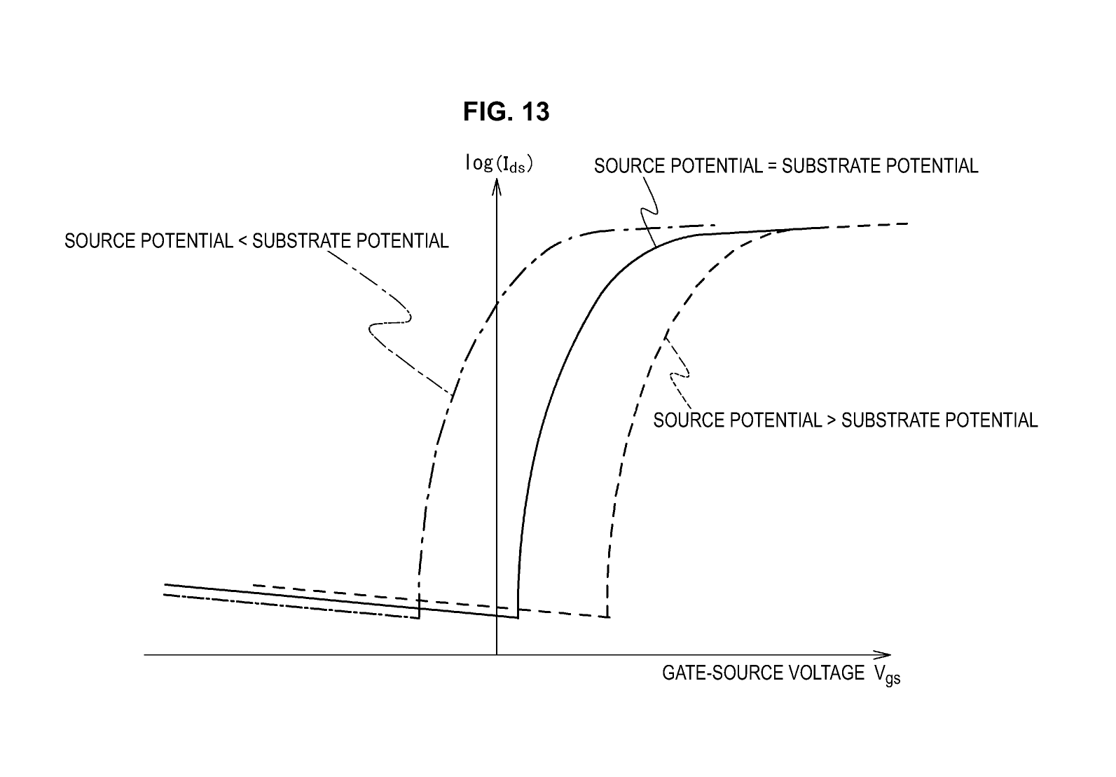

When the TFT is formed over the semiconductor, as illustrated in FIG. 13, a characteristic of the TFT is changed by the substrate potential. Specifically, if a difference of the substrate potential and the source potential is positive (substrate potential>source potential), a threshold voltage of the TFT is shifted to an enhancement side. In contrast, if the difference of the substrate potential and the source potential is negative (substrate potential<source potential), the threshold voltage of the TFT is shifted to a depression side.

Here, each of an effect of the parasitic capacitor existing between the terminals of the transistor and the substrate and an effect of the characteristic change by the potential difference of the source potential and the substrate potential is considered.

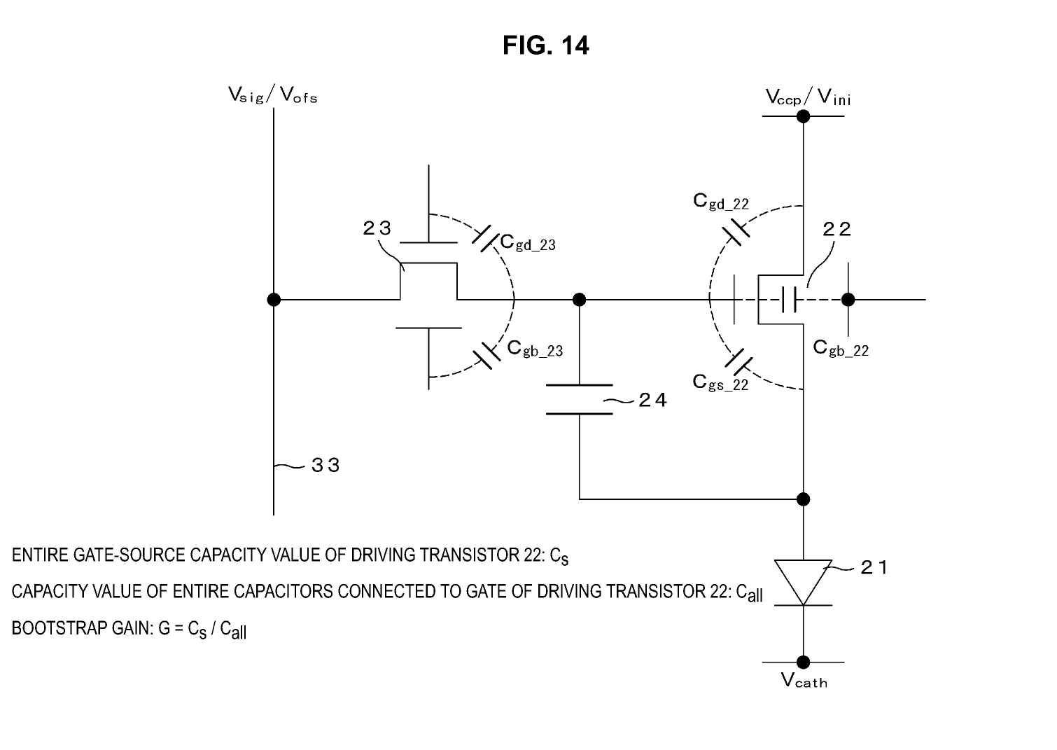

When the four-terminal transistor illustrated in FIG. 12 is used in the pixel circuit of FIG. 2, a parasitic capacitor is generated in the gate electrode (terminal) of the driving transistor 22, as illustrated in FIG. 14. At this time, if a capacity value of entire capacitors connected to the gate electrode of the driving transistor 22 is set to Cₐₗₗ and a gate-source capacity value of the driving transistor 22 is set to Cₛ, the bootstrap gain G in the bootstrap operation becomes Cₛ/Cₐₗₗ.

In this case, the capacity value Cₐₗₗ is an entire capacity value of a gate-source capacitor C_{gs}_{_{—}}₂₂, a gate-drain capacitor C_{gd}_{_{—}}₂₂, and a gate-back gate capacitor C_{gb}_{_{—}}₂₂ of the driving transistor 22, a gate-drain capacitor C_{gd}_{_{—}}₂₃ and a gate-back gate capacitor C_{gb}_{_{—}}₂₃ of the write transistor 23, and the retention capacitor 24. The capacity value Cₛ is an entire capacity value of the gate-source capacitor C_{gs}_{_{—}}₂₂ of the driving transistor 22 and the retention capacitor 24.

The bootstrap gain G shows a ratio of a change (variation amount) of the gate potential with respect to a change (variation amount) of the source potential of the driving transistor 22. That is, if the bootstrap gain G is 1 (ideal value), the change of the gate potential becomes matched with the change of the source potential of the driving transistor 22. If the capacity other than the gate-source capacity of the driving transistor 22 is very smaller than the gate-source capacity, the gate-source voltage V_{gs} of the driving transistor 22 is retained almost constantly when the organic EL element 21 emits light.

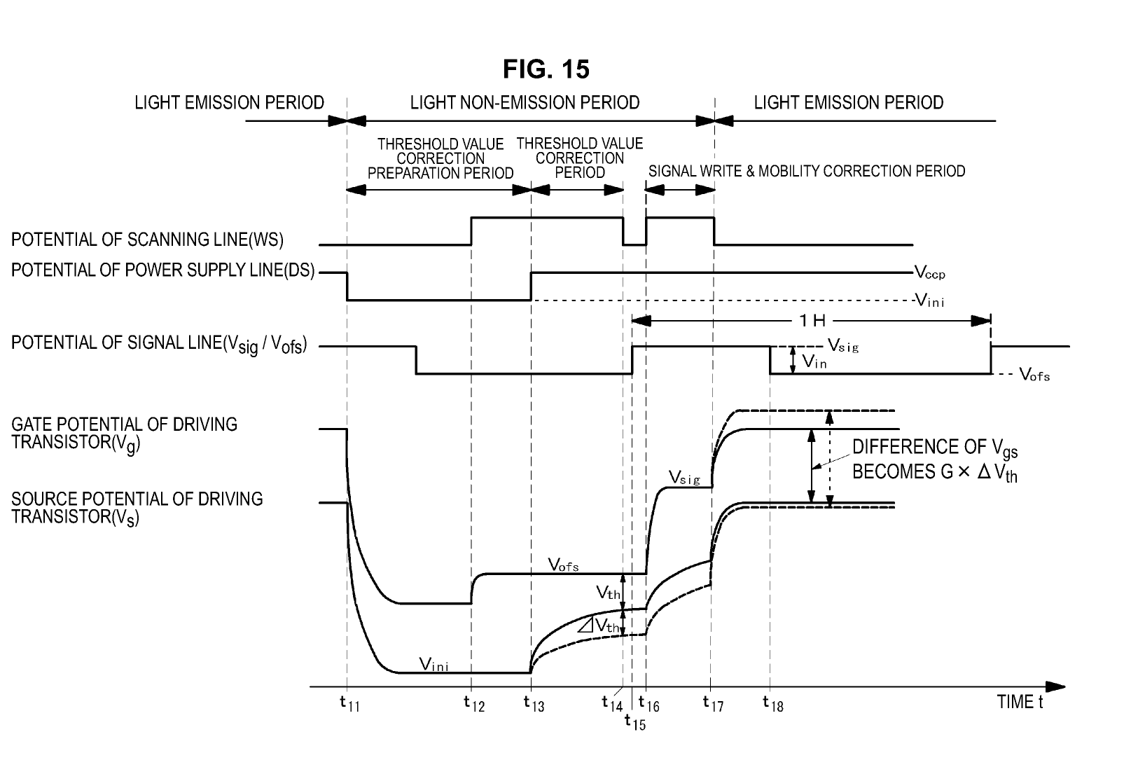

However, as illustrated in FIG. 14, when the parasitic capacitor exists between each terminal of the transistor and the substrate, the bootstrap gain G decreases because the capacity other than the gate-source capacity of the driving transistor 22 may become more than the gate-source capacity. Thereby, as illustrated in FIG. 15, if a difference (=ΔVₜₕ) exists in the threshold voltage Vₜₕ of the driving transistor 22 between the pixels, a difference (G×ΔVₜₕ) of the gate-source voltage V_{gs} of the driving transistor 22 when light emits may become smaller than ΔVₜₕ and ΔVₜₕ may not be perfectly reflected. As a result, a brightness irregularity or roughness occurs in a display image and image quality of the display image is deteriorated.

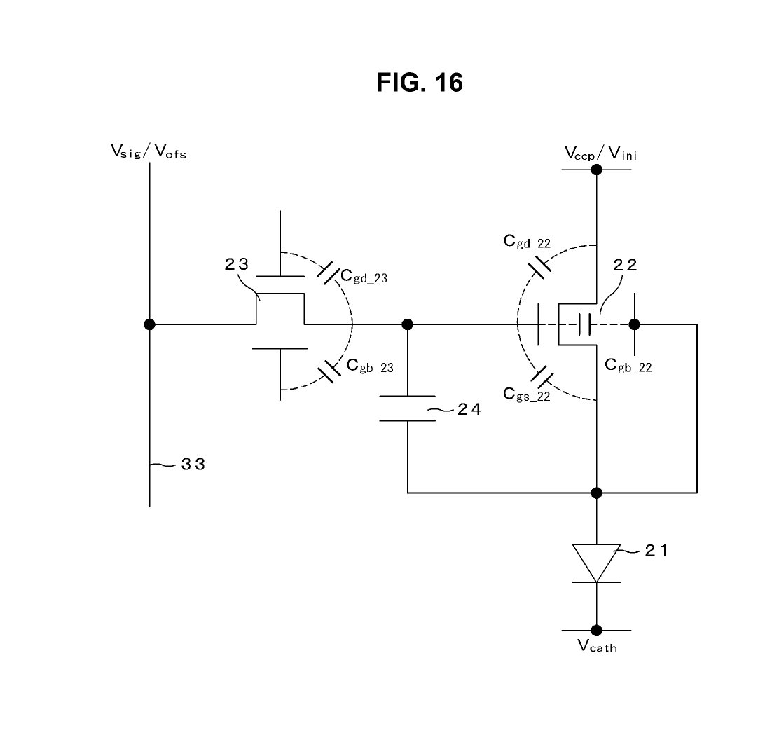

In order to increase the bootstrap gain G, the capacity value of the parasitic capacitor that is attached to the gate electrode of the driving transistor 22 may be decreased. For example, as illustrated in FIG. 16, a method of decreasing the capacity value of the parasitic capacitor between the gate electrode of the driving transistor 22 and the substrate by connecting the source electrode of the driving transistor 22 and the substrate, that is, equalizing the source potential Vₛ and the substrate potential is considered.

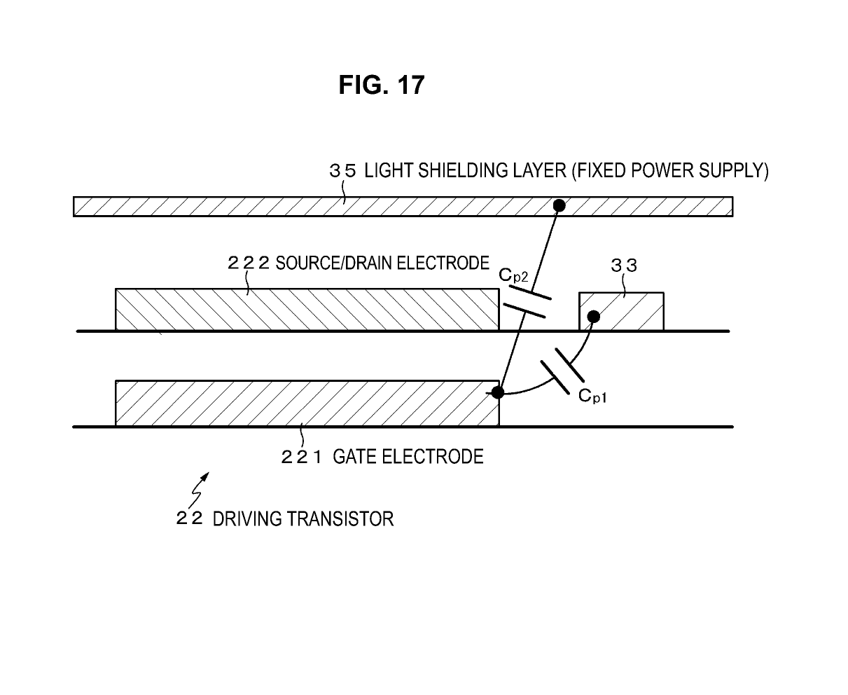

However, in a process for forming the TFT over a semiconductor substrate such as a silicon substrate, as illustrated in FIG. 17, it is general to perform multi-layering of a wiring line including a signal line 33 or a gate electrode 221 and a source/drain electrode 222 of the driving transistor 22. A light shielding layer 35 supplied with fixed power is arranged to decrease an influence of external light with respect to a circuit element such as the driving transistor 22. However, if a multi-layer wiring structure is implemented, parasitic capacitors Cₚ₁ and Cₚ₂ may be generated between the gate electrode 221 of the driving transistor 22 and a metal (in an example of FIG. 17, the signal line 33 or the light shielding layer 35) of other layer.

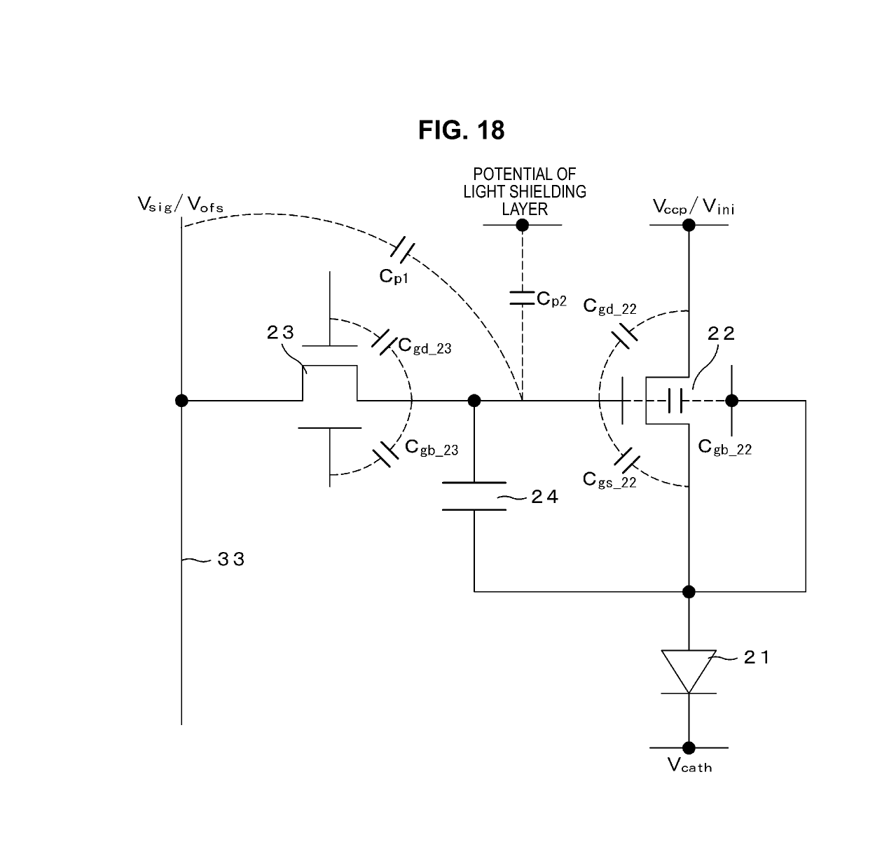

As such, if the multi-layer wiring structure is implemented when the TFT is formed over the semiconductor, the parasitic capacitors Cₚ₁ and Cₚ₂ that are attached to the gate electrode of the driving transistor 22 decrease the bootstrap gain G. FIG. 18 illustrates an equivalent circuit of the parasitic capacitors attached to the gate electrode of the driving transistor 22 in the case of the multi-layer wiring structure.

As described above, if the difference (=ΔVₜₕ) exists in the threshold voltage Vₜₕ of the driving transistor 22, the difference (G×ΔVₜₕ) of the gate-source voltage V_{gs} of the driving transistor 22 when the light emits may become smaller than ΔVₜₕ and ΔVₜₕ may not be perfectly reflected. As a result, the brightness irregularity or the roughness may occur in the display image.

The decrease in the bootstrap gain G is generated equally in the case in which the driving transistor 22 is formed over the insulator formed over the semiconductor such as the metal as well as the case in which the driving transistor 22 is formed over the semiconductor. This is because, when the TFT having the bottom gate structure is formed over the conductor substrate with the insulator therebetween, the TFT does not become a four-terminal element, but an entire portion between the conductor substrate and the gate electrode may become a parasitic capacitor, as described above.

### <3. Embodiment>

An organic EL display device according to an embodiment of the present disclosure is configured to resolve a problem occurring when the driving transistor 22 is formed over the semiconductor such as the silicon or the insulator formed over the conductor substrate. This problem is a (problem occurring due to the effect of the substrate potential and the bootstrap gain G when the driving transistor 22 is formed over the semiconductor or a problem occurring due to a decrease in the bootstrap gain G when the driving transistor 22 is formed over the insulator formed over the conductor substrate, as described above.

In order to resolve the above problem, in this embodiment, the following configuration is adopted in a multi-layer wiring structure configured by stacking the gate electrode 221 and the source/drain electrode 222 of the driving transistor 22, that is, a multi-layer wiring structure configured by arranging a source/drain metal layer over a gate metal layer.

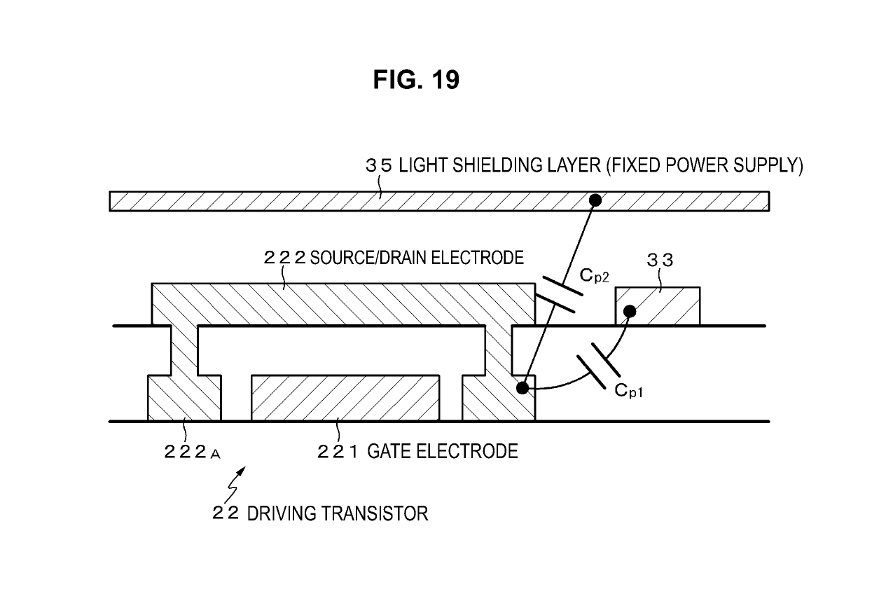

That is, as illustrated in FIG. 19, in this embodiment, a structure in which a peripheral portion of the gate electrode 221 is three-dimensionally covered by the source/drain electrode 222 is adopted. Specifically, a tubular portion 222_{A} protruding to the side of the gate electrode 221 is formed in the source/drain electrode 222 and the peripheral portion of the gate electrode 221 is covered by the tubular portion 222_{A} and the source/drain electrode 222.

In this case, the source/drain electrode 222 is one source/drain electrode of the driving transistor 22. In the multi-layer wiring structure, a channel formation layer or the other source/drain electrode of the driving transistor 22 is formed in a layer (other layer) different from the gate electrode 221 or one source/drain electrode 222.

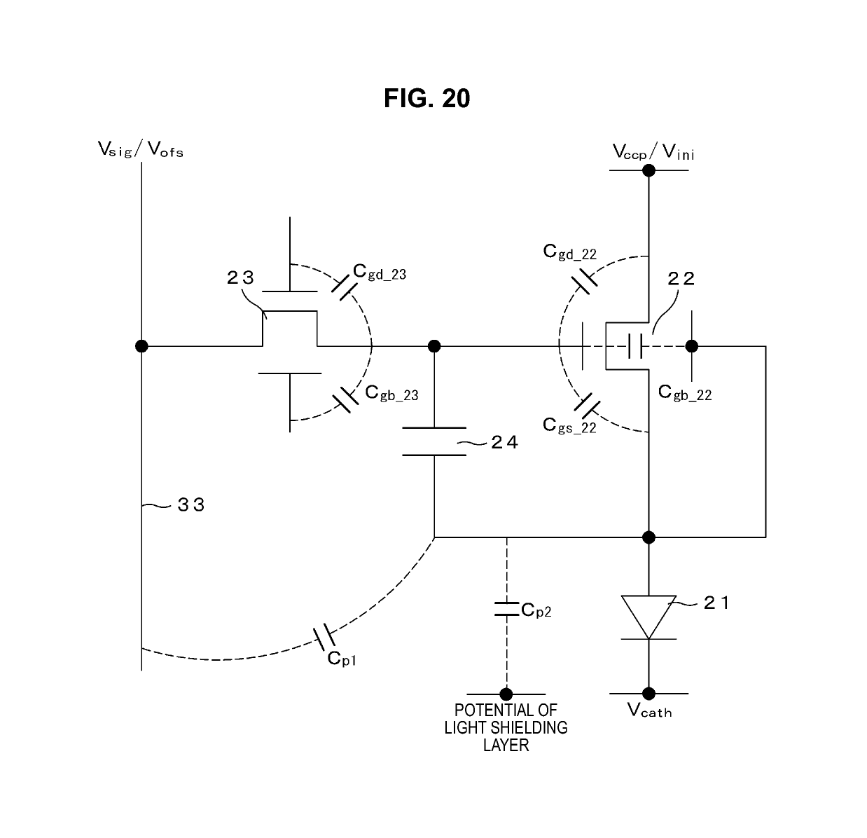

As described above, in the multi-layer wiring structure, by adopting the structure in which the peripheral portion of the gate electrode 221 is three-dimensionally covered by the source/drain electrode 222, the parasitic capacitor is not generated between the gate electrode 221 of the driving transistor 22 and the metal of other layer, for example, the signal line 33 or the light shielding layer 35. Instead, as illustrated in FIG. 20, the parasitic capacitors Cₚ₁ and Cₚ₂ are generated between the source/drain electrode 222 of the driving transistor 22 and the metal of other layer, for example, the signal line 33 or the light shielding layer 35.

As described above, the bootstrap gain G is determined by the capacity value of the retention capacitor 24 and the capacity values of the parasitic capacitors attached to the gate electrode of the driving transistor 22. In the multi-layer wiring structure, the parasitic capacitor is not generated between the gate electrode of the driving transistor 22 and the metal of other layer, so that the capacity values of the parasitic capacitors attached to the gate electrode decrease, as compared with the case in which the gate electrode 221 is not three-dimensionally covered. Therefore, the bootstrap gain G can be increased.

By increasing the bootstrap gain G, the difference ΔVₜₕ of the threshold voltage Vₜₕ when the difference (=ΔVₜₕ) exists in the threshold voltage Vₜₕ of the driving transistor 22 between the pixels can be reflected in the gate potential V_{g} and the source potential Vₛ of the driving transistor 22 during the bootstrap period after the threshold value correction operation. Thereby, finally, the gate-source voltage V_{gs} of the driving transistor 22 when the light emits after the signal write ends may not be affected by the difference ΔVₜₕ of the threshold voltage Vₜₕ. Therefore, uniform image quality in which there is no brightness irregularity or roughness can be obtained.

The parasitic capacitors Cₚ₁ and Cₚ₂ are generated between the source/drain electrode 222 of the driving transistor 22 and the signal line 33 or the light shielding layer 35, so that the gate-source capacity value of the driving transistor 22 can be increased. The gate-source capacity value of the driving transistor 22 increases, so that the change amount ΔVₛ of the source potential Vₛ of the driving transistor 22 in the mobility correction operation is moderated. Therefore, an image quality defect such as shading occurring due to the difference of the signal write time between the pixels can be decreased.

### <4. Modification>

It should be understood by those skilled in the art that various modifications, combinations, sub-combinations and alterations may occur depending on design requirements and other factors insofar as they are within the scope of the appended claims or the equivalents thereof. That is, in the embodiment, in the multi-layer wiring structure, the channel formation layer of the driving transistor 22 is formed in the layer (other layer) different from the gate electrode 221 or one source/drain electrode 222. However, the present disclosure is not limited thereto.

For example, a structure in which the channel formation layer of the driving transistor 22 is arranged in the same layer as a gate metal layer (layer in which the gate electrode 221 is formed) or a region in which a peripheral region is covered by a source/drain metal layer (layer in which one source/drain electrode 222 is formed) can be adopted.

By adopting this structure, the channel formation layer of the driving transistor 22 can be shielded from the light by the source/drain metal layer. Therefore, because the light shielding layer 35 (refer to FIG. 19) to shield the channel formation layer from the light can be removed, a manufacturing cost can be decreased.

### <5. Electronic Apparatus>

The display device according to an embodiment of the present disclosure described above can be used as a display unit (display device) in each of electronic apparatuses of all fields that display a video signal input to the electronic apparatuses or a video signal generated in the electronic apparatuses as an image or video.

As apparent from the explanation of the embodiment, because the display device according to an embodiment of the present disclosure can increase the bootstrap gain, the image quality defect such as the brightness irregularity or the roughness can be decreased. Therefore, in the electronic apparatuses of all fields, high-quality image display can be realized by using the display device according to an embodiment of the present disclosure as the display unit.

As the electronic apparatuses that use the display device according to an embodiment of the present disclosure as the display unit, a digital camera, a video camera, a game machine, and a notebook computer can be exemplified, in particular, the display device according to an embodiment of the present disclosure is suitable for a display unit in each of electronic apparatuses, such as a portable information apparatus such as an electronic book reader or an electronic wristwatch or a portable communication apparatus such as a mobile phone or a personal digital assistant (PDA).

### <6. Configuration of Present Disclosure>

Additionally, the present disclosure may also be configured as below.
(1) A display device including:

pixel circuits which are arranged and each of which includes a driving transistor to drive an electro-optical element and a capacitor connected between a gate electrode and one source/drain electrode of the driving transistor,

wherein the driving transistor is configured by stacking the gate electrode and the source/drain electrode and a peripheral portion of the gate electrode is covered by the source/drain electrode.
(2) The display device according to (1),

wherein a peripheral portion of a channel formation layer of the driving transistor is covered by the source/drain electrode.
(3) The display device according to (1) or (2),

wherein the driving transistor is formed over a semiconductor.
(4) The display device according to (1) or (2),

wherein the driving transistor is formed over an insulator formed over a conductor.
(5) The display device according to any one of (1) to (4),

wherein the pixel circuit flows a current to the driving transistor and performs writing of a video signal and mobility correction of the driving transistor.
(6) The display device according to (5),

wherein the pixel circuit applies negative feedback to a gate-source potential difference of the driving transistor with a correction amount according to the current flowing to the driving transistor and performs the mobility correction of the driving transistor.
(7) An electronic apparatus including:

a display device including pixel circuits which are arranged and each of which includes a driving transistor to drive an electro-optical element,

wherein the driving transistor is configured by stacking a gate electrode and a source/drain electrode and a peripheral portion of the gate electrode is covered by the source/drain electrode.

The present disclosure contains subject matter related to that disclosed in Japanese Priority Patent Application JP 2012-191640 filed in the Japan Patent Office on Aug. 31, 2012, the entire content of which is hereby incorporated by reference.

What is claimed is:

1. A display device comprising:
pixel circuits which are arranged and each of which includes a driving transistor to drive an electro-optical element and a capacitor connected between a gate electrode and one source/drain electrode of the driving transistor,
wherein the driving transistor is configured by stacking the gate electrode and the source/drain electrode and a peripheral portion of the gate electrode is covered by the source/drain electrode.

2. The display device according to claim 1,
wherein a peripheral portion of a channel formation layer of the driving transistor is covered by the source/drain electrode.

3. The display device according to claim 1,
wherein the driving transistor is formed over a semiconductor.

4. The display device according to claim 1,
wherein the driving transistor is formed over an insulator formed over a conductor.

5. The display device according to claim 1,
wherein the pixel circuit flows a current to the driving transistor and performs writing of a video signal and mobility correction of the driving transistor.

6. The display device according to claim 5,
wherein the pixel circuit applies negative feedback to a gate-source potential difference of the driving transistor with a correction amount according to the current flowing to the driving transistor and performs the mobility correction of the driving transistor.

7. An electronic apparatus comprising:
a display device including pixel circuits which are arranged and each which includes a driving transistor to drive an electro-optical element,
wherein the driving transistor is configured by stacking a gate electrode and a source/drain electrode and a peripheral portion of the gate electrode is covered by the source/drain electrode.
